(19) United States
(12) Patent Application Publication
(10) Pub. No.: US 2022/0254325 A1
(43) Pub. Date: Aug. 11, 2022

(54) WEARABLE SPEAKER

(71) Applicant: SONY GROUP CORPORATION, TOKYO (JP)

(72) Inventors: SHUICHIRO NISHIGORI, TOKYO (JP); TAKAHIRO WATANABE, TOKYO (JP); HIROFUMI TAKEDA, TOKYO (JP); SHIRO SUZUKI, TOKYO (JP)

(21) Appl. No.: 17/627,731

(22) PCT Filed: Jun. 11, 2020
(86) PCT No.: PCT/JP2020/022980

§ 371 Date: Jan. 17, 2022

(30) Foreign Application Priority Data
Jul. 29, 2019 (JP) 2019-138454

(51) Int. Cl. G10K 11/16; H04R 1/02

(52) U.S. Cl. CPC G10K 11/16; H04R 1/026

(57) ABSTRACT

A wearable speaker includes a housing to be used by being hung around a neck of a user or carried on a shoulder of the user, a speaker capable of reproducing an audio signal, and one or more vibration sections capable of reproducing vibration signals.

### TECHNICAL FIELD

The present disclosure relates to a wearable speaker worn on a user's body by being hung around a neck, carried on a shoulder, or worn in any other manner.

### BACKGROUND ART

Speakers, headphones, earphones, and the like have been available as apparatuses for producing audio. Because a speaker radiates sound into a space, not only a person at a distance but also a number of people can hear the sound. A headphone allows a person to personally hear the sound. An earphone is compact and has good portability.

As apparatuses having these features combined, wearable speakers (also called neck speakers) carried around a neck or on a shoulder by users to enjoy music and audio of video images have been proposed in recent years. A wearable speaker radiates sound from its speakers near the user's ears, making it possible to provide ample listening experience even with a low audio level and keeps adverse impacts of sound leakage to a surrounding environment to a minimum as compared to speakers.

Further, some wearable speakers have an apparatus called a passive radiator that does not include any electromagnetic circuit but generates a low frequency vibration by taking advantage of resonance of air vibrations produced in a speaker and amplify the intensity of deep bass by presenting a vibration commensurate with the sound (refer to PTL 1 and PTL 2).

### CITATION LIST

### Patent Literature

### [PTL1]

Japanese Patent No. 6435075

### [PTL2]

Japanese Patent No. 6363241

### SUMMARY

### Technical Problem

In such a field, there has been a demand to allow users to experience vibrations desirable to the users.

### Solution to Problem

The present disclosure is, for example, a wearable speaker that includes a housing, a speaker, and one or more vibration sections. The housing is used by being hung around a user's neck or carried on his or her shoulder. The speaker can reproduce an audio signal. The vibration sections can reproduce vibration signals.

### BRIEF DESCRIPTION OF DRAWINGS

FIG. 1 depicts diagrams illustrating a configuration of a wearable speaker according to a first embodiment.

FIG. 2 is a perspective view illustrating a configuration of the wearable speaker according to the first embodiment.

FIG. 3 is a diagram illustrating the manner in which the wearable speaker according to the first embodiment is worn.

FIG. 4 is a side view of the wearable speaker according to the first embodiment.

FIG. 5 is a cross-sectional view for describing the manner in which a vibration section according to the first embodiment is attached.

FIG. 6 is a perspective view illustrating configurations of the vibration section and a support section according to the first embodiment.

FIG. 7 is a block diagram illustrating control components of the wearable speaker according to the first embodiment.

FIG. 8 depicts diagrams illustrating various characteristics of the wearable speaker according to the first embodiment.

FIG. 9 is a diagram illustrating a data configuration used by the wearable speaker according to the first embodiment.

FIG. 10 depicts diagrams illustrating a configuration of a wearable speaker according to a second embodiment.

FIG. 11 is a cross-sectional view illustrating a configuration of the wearable speaker according to the second embodiment.

FIG. 12 depicts diagrams illustrating a configuration of the wearable speaker according to the second embodiment.

FIG. 13 depicts diagrams illustrating a configuration of the wearable speaker according to the second embodiment.

FIG. 14 is a cross-sectional view illustrating a configuration of a wearable speaker according to a modification example.

FIG. 15 is a cross-sectional view illustrating a configuration of a wearable speaker according to a modification example.

FIG. 16 is a cross-sectional view illustrating a configuration of a wearable speaker according to a modification example.

FIG. 17 depicts diagrams illustrating a configuration of a wearable speaker according to a modification example.

FIG. 18 is a side view of a vibration section according to a modification example.

FIG. 19 is a side view of a vibration section according to a modification example.

FIG. 20 is a diagram illustrating a frequency characteristic of a wearable speaker according to a modification example.

### DESCRIPTION OF EMBODIMENTS

A description will be given below of embodiments of the present disclosure with reference to drawings. It should be noted that the description will be given in the following order.

<1. First embodiment>

<2. Second embodiment>

<3. Modification examples>

The embodiments and the like which will be described below are suitable specific examples of the present disclosure, and contents of the present disclosure are not limited to these embodiments.

### 1. First Embodiment

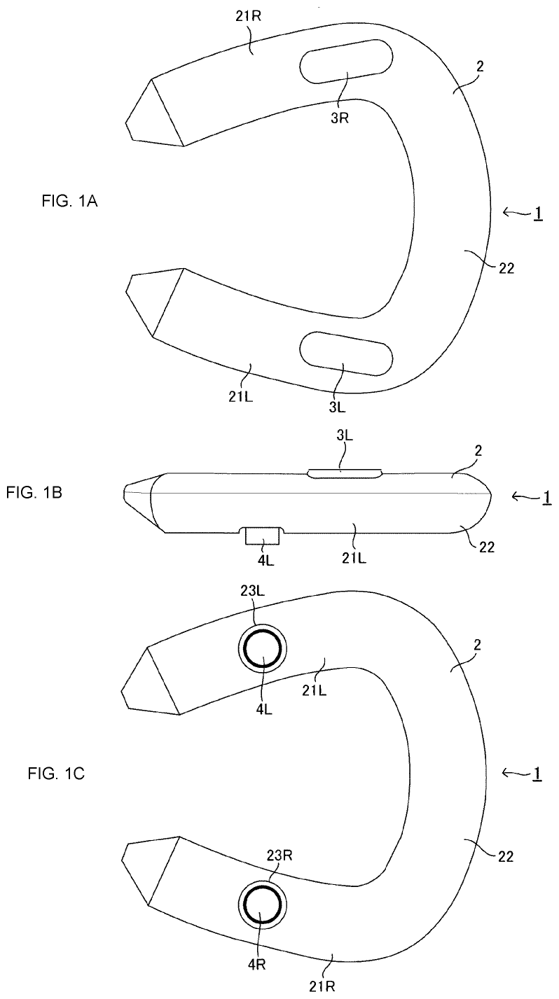

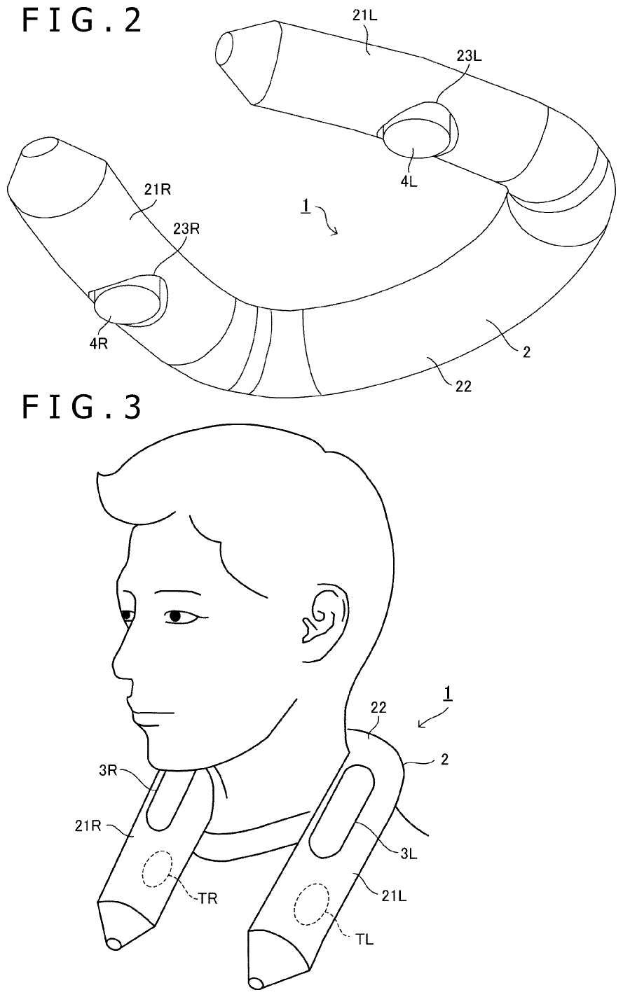

FIGS. 1 to 8 are diagrams describing a wearable speaker 1 according to a first embodiment. FIG. 1 depicts three-view drawings of the wearable speaker 1. FIG. 1(A) is a top view of the wearable speaker 1, FIG. 1(B) is a side view of the wearable speaker 1, and FIG. 1(C) is a bottom view of the wearable speaker 1. In addition, FIG. 2 illustrates a perspective view of the wearable speaker 1 as seen from below.

As is clear from FIGS. 1(A) and 1(C), the wearable speaker 1 according to the present embodiment includes a housing 2 whose two arms 21R and 21L are connected to each other by a connection section 22. As illustrated in FIGS. 1(A) and 1(B), speakers 3R and 3L are respectively provided on upper surfaces of the arms 21R and 21L, making it possible to produce right and left stereo audio. Also, as illustrated in FIGS. 1(A) and 1(B), opening sections 23R and 23L are provided in lower surfaces of the arms 21R and 21L, and vibration sections 4R and 4L are provided in such a manner as to be positioned inside the opening sections 23R and 23L in question. As described above, the vibration sections 4R and 4L of the present embodiment are provided in a manner of being embedded in the housing 2 of the wearable speaker 1.

FIG. 3 illustrates the manner in which the wearable speaker 1 according to the present embodiment is worn by a user. The wearable speaker 1 according to the present embodiment is used by being hung around the neck. When the wearable speaker 1 is used, it is preferred that the speakers 3R and 3L be arranged at positions as close to the user's ears as possible. Accordingly, the speakers 3R and 3L are arranged at positions that come immediately under the ears and are oriented in such a manner as to emit acoustic waves upward when the wearable speaker 1 is hung around the neck. It should be noted that, in the case where audio is to be reproduced from the back as when a surround effect is produced, a speaker may be added at a position right behind the neck when the wearable speaker 1 is worn by the user, for example, at the connection section 22. Also, the wearable speaker 1 may not only be hung around the neck as in the present embodiment but also be carried on the shoulder or worn in any other manner.

Meanwhile, contact positions TR and TL indicated by dashed lines in FIG. 3 indicate the positions where the vibration sections 4R and 4L described in FIGS. 1 and 2 come into contact with the user's body. In the present embodiment, setting the contact positions TR and TL at areas close to clavicles where the user is sensitive to vibrations makes it possible to effectively transfer the vibrations generated by the vibration sections 4R and 4L to the user. Specifically, the positions where the vibration sections 4R and 4L are provided are moved to positions more on tip sides of the arms 21R and 21L than the positions of the speakers 3R and 3L. Also, in the present embodiment, when the wearable speaker 1 is worn, the vibration sections 4R and 4L are respectively arranged on right and left sides (right and left halves) of the user's body, making it possible to transfer vibrations to the right and left sides of the user's body. Accordingly, using different drive signals for driving the vibration sections 4R and 4L makes it possible to transfer different vibrations to the right and left sides of the user's body.

An eccentric motor, a linear actuator, a voice coil motor, a piezo actuator, and the like can be used as elements of the vibration sections 4R and 4L. A voice coil motor is preferred from the viewpoint of time response and wideband reproducibility. It should be noted, however, that in the case where restrictions are imposed by other factors such as cost, vibration intensity, drive voltage, power consumption, and size, types of elements other than a voice coil motor can be used as the vibration sections 4R and 4L.

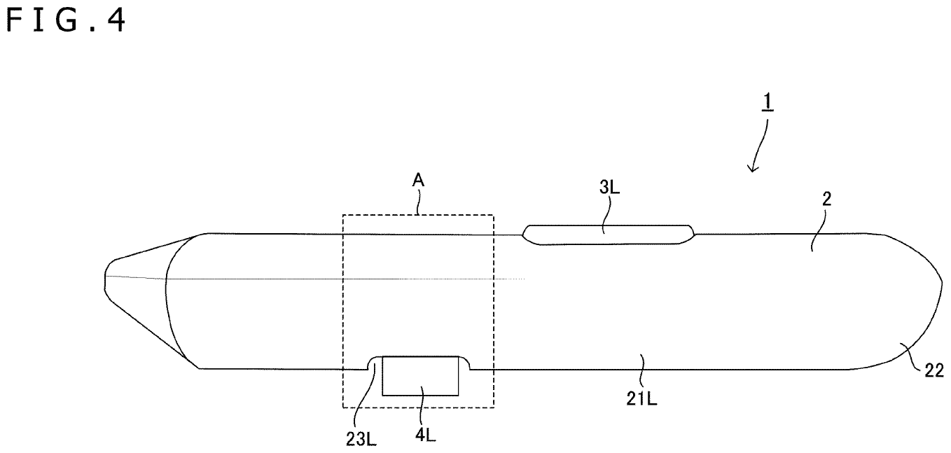

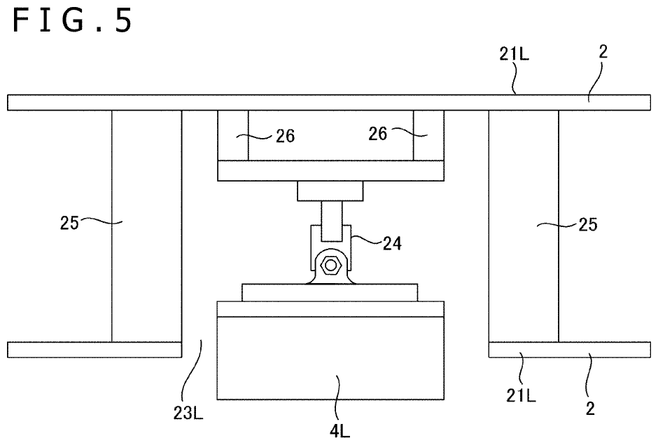

A description will next be given of the manner of attaching the vibration sections 4R and 4L to the wearable speaker 1. FIG. 4 is a side view of the wearable speaker 1, and a nearby area of the vibration section 4L of the left arm 21L is enclosed by a dashed line A. FIG. 5 is a cross-sectional view of the area enclosed by the dashed line A in FIG. 4. The side of the right arm 21R has a similar configuration. Accordingly, redundant descriptions will be omitted as appropriate. The opening section 23L for providing the vibration section 4L is provided on the housing 2 (arm 21L) of the present embodiment. The vibration section 4L is attached in such a manner that a part thereof is embedded in the space inside the opening section 23L. Because only a part of the vibration section 4L protrudes from the housing 2, the housing 2 is prevented, to the extent possible, from rising at the time of being attached, even in the case where the vibration section 4L is thick. Also, it is possible to reduce annoying noise generated by the vibration section 4L when a high frequency vibration is output. Also, because the vibration section 4L is provided under the housing 2 in the present embodiment, the vibration section 4L is pressed against a human body by an own weight of the housing 2, making it possible to increase the efficiency for transferring the vibration.

The vibration section 4L is attached to an inner upper area of the housing 2 via a cushioning material 26 and a support section 24. The cushioning material 26 is a member provided to prevent the housing 2 worn by the user from swinging vertically due to reaction to the vibration of the vibration section 4L and is provided between the support section 24 that supports the vibration section 4L and an inner surface of the housing 2. The cushioning material 26 has a certain degree of rigidity as does an elastic elastomer and absorbs the reaction to the vibration while improving the efficiency for transferring the vibration by pressing of the vibration section 4L against the human body by the own weight of the housing 2 owing to its floating structure achieved by use of a vibration absorbing material. Also, a sound absorbing material 25 which is arranged in such a manner as to surround the vibration section 4L, the support section 24, and the like is provided inside the housing 2. The sound absorbing material 25 is provided to absorb part of annoying noise generated by the vibration section 4L when a high frequency vibration is output and reduce noise that may leak to an outside environment.

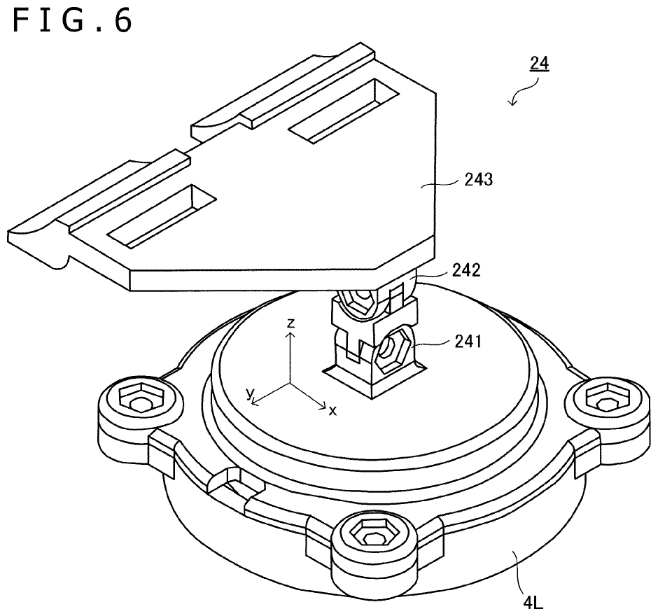

FIG. 6 is a diagram illustrating configurations of the vibration section 4L and the support section 24. The support section 24 includes two hinge sections 241 and 242 and a base section 243. Coordinate axes for reference are illustrated on the left side of the hinge section 241 in FIG. 6. The hinge section 241 can rotate about an x-axis with respect to the hinge section 242. Further, the hinge section 242 can rotate about a y-axis with respect to the base section 243. Accordingly, the vibration section 4L can rotate about the x- and y-axes with respect to the base section 243.

Because the base section 243 is attached to the housing 2 via the cushioning material 26 as illustrated in FIGS. 5 and 6, the vibration section 4L can cause its flat lower surface to rotate freely with respect to the housing 2. Accordingly, it is possible to press the lower surface of the vibration section 4L tightly against the user's body when the wearable speaker 1 is worn. It should be noted that the opening section 23L is preferably sized such that when the vibration section 4L is rotated by the support section 24, the vibration section 4L does not come into contact with the opening section 23L or such that the support section 24 preferably has a range of rotation that ensures that the vibration section 4L does not come into contact with the opening section 23L.

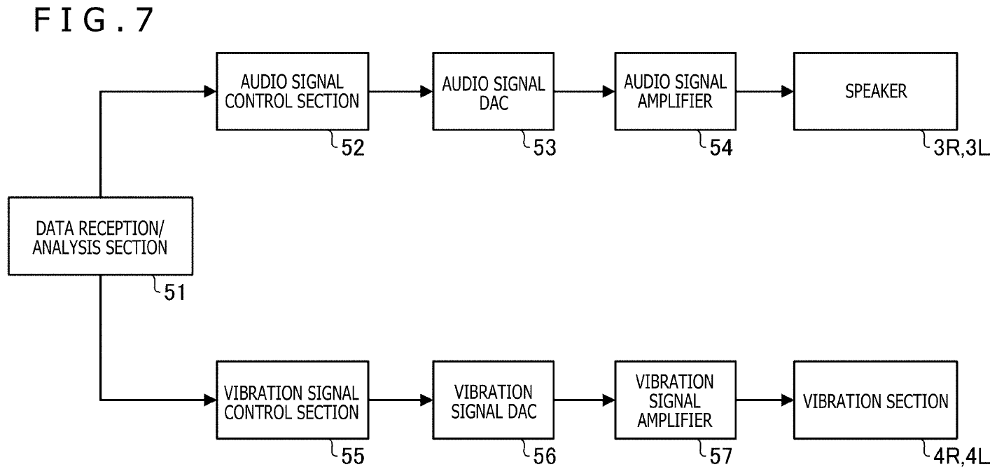

FIG. 7 is a block diagram illustrating control components of the wearable speaker 1. The control components are driven by using only an audio signal or by using not only an audio signal but also a vibration signal. A description will be given below of each manner of driving. It should be noted that, although the control components illustrated in FIG. 7 are accommodated in the housing 2 of the wearable speaker 1 in the present embodiment, some of the control components may be arranged outside the housing 2.

### (Driving Using Only an Audio Signal)

In the case where audio of existing music content or video image content is to be reproduced, digital audio data wirelessly transmitted from a transmitter (not illustrated) is received by a data reception/analysis section 51, and an audio signal is sent to an audio signal control section 52 and a vibration signal control section 55. The audio signal may be linear PCM of Raw data or coded data compressed by an audio codec such as MP3 or AAC. In the case of compressed coded data, linear PCM can be obtained by performance of a decoding process commensurate with each coding scheme by the data reception/analysis section 51.

In the audio signal control section 52, sound volume adjustment and sound quality adjustment by an equalizer are performed, and are followed by conversion of a digital signal into an analog signal by an audio signal DAC 53. Then, the analog signal is amplified by an audio signal amplifier 54 and reproduced by each of the speakers 3R and 3L. In a vibration signal control section 55, a vibration signal is generated using the audio signal, and vibration level adjustment is performed, after which a digital signal is converted into an analog signal by a vibration signal DAC 56. Then, the analog signal is amplified by a vibration signal amplifier 57 and reproduced by each of the vibration sections 4R and 4L. Here, a possible method of generating a vibration signal with use of an audio signal would be to generate, as a vibration signal, a signal whose audio signal band is limited.

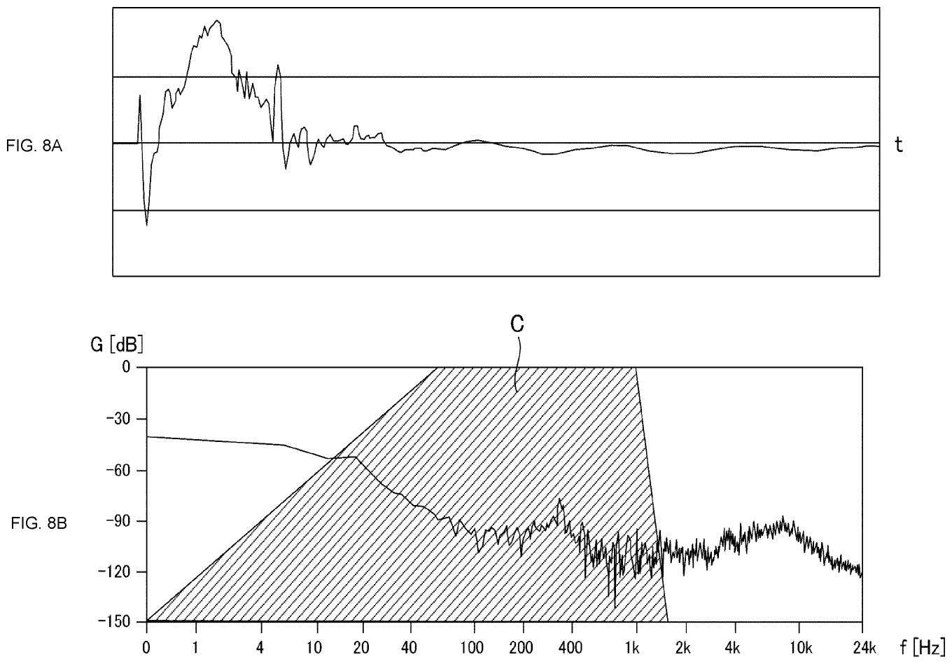

FIG. 8 depicts diagrams illustrating various characteristics of the wearable speaker 1, and FIG. 8(A) is an example of an audio signal input to the wearable speaker 1 and illustrates an amplitude with respect to elapsed time. In addition, FIG. 8(B) illustrates a frequency characteristic (spectrum) of FIG. 8(A). Here, a trapezoidal shaded area C illustrated in FIG. 8(B) is a band-pass filter (with an effective passband from approximately 50 Hz to approximately 1 kHz) used in the vibration signal control section 55, and a vibration signal is created by applying this band-pass filter to an audio signal.

### (Driving Using an Audio Signal and a Vibration Signal)

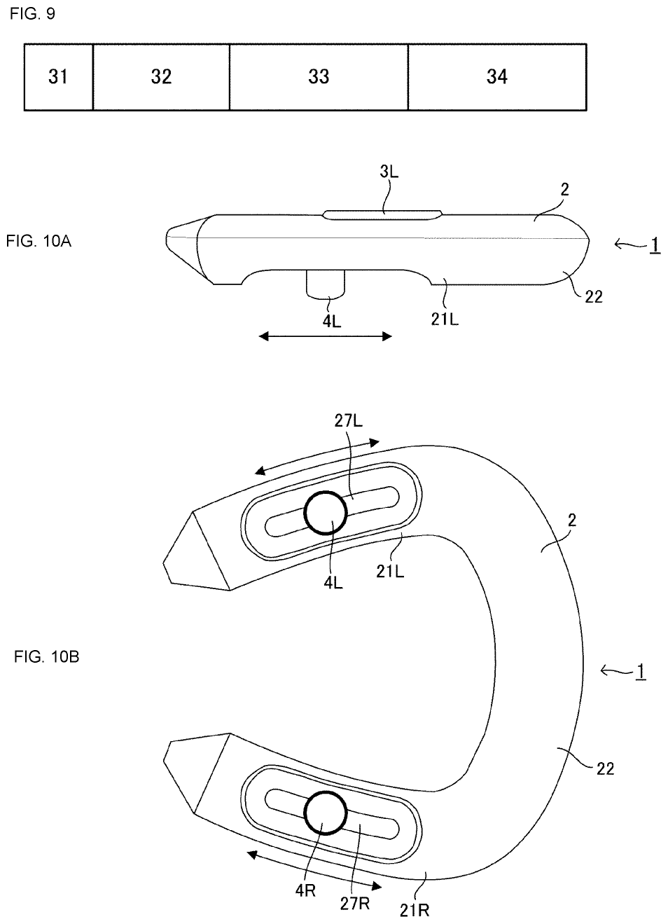

Further, content created by a creator by making available an original vibration signal separately from an audio signal may be wirelessly transmitted to the data reception/analysis section 51 from the transmitter (not illustrated). FIG. 9 illustrates an example of a frame format in which audio data 33 and vibration data 34 are stored. The frame format includes a frame sync word 31 for recognizing the beginning of a frame, frame information 32 in which such frame information as data size and the number of audio signal and vibration signal channels is stored, audio data 33 equal in number to the number of channels, and vibration data 34 equal in number to the number of channels. The audio data 33 and the vibration data 34 are stored in a channel interleaved format as long as they are in linear PCM, and in the case where these pieces of data are coded by a codec for data compression, one frame worth of bitstream is stored in each piece of data.

The data reception/analysis section 51 sends the audio data and the vibration data obtained by analyzing the frame format described with reference to FIG. 9 to the audio signal control section 52 and the vibration signal control section 55, respectively. Thereafter, the audio data is sent to the speakers 3R and 3L via the audio signal DAC 53 and the audio signal amplifier 54 and reproduced by the speakers 3R and 3L. Also, the vibration data is sent to the vibration sections 4R and 4L via the vibration signal DAC 56 and the vibration signal amplifier 57 and reproduced by the vibration sections 4R and 4L. It should be noted that, in the case where the control components are driven by using an audio signal and a vibration signal, vibration data is created in advance for vibration, and it is thus unnecessary to apply a band-pass filter to the vibration signal as described with reference to FIG. 8.

Although the two manners of driving the wearable speaker 1 have been described above, either one of these two manners of driving may be used or both of them may be made available by switching from one to the other and vice versa. In the case where two manners are used by switching from one to the other and vice versa, it is possible to switch between the two manners manually or automatically according to the type of data received by the data reception/analysis section 51.

The wearable speaker 1 according to the present embodiment has been described above, and the wearable speaker 1 of the present embodiment allows the user to experience vibrations desirable to the user owing to the vibration sections 4R and 4L provided therein to generate vibrations.

### 2. Second Embodiment

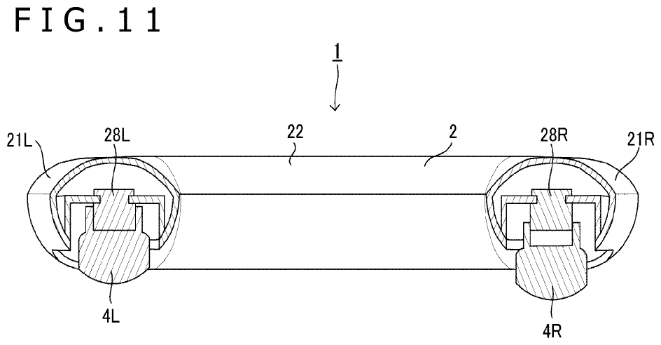

A description will next be given of a wearable speaker 1 according to a second embodiment with reference to FIGS. 10 to 13. FIG. 10 depicts diagrams illustrating a configuration of the wearable speaker 1; FIG. 10(A) illustrates a side view of the wearable speaker 1, and FIG. 10(B) illustrates a bottom view of the wearable speaker 1. Because the wearable speaker 1 of the present embodiment is similar to that of the first embodiment except for the manner of attaching the vibration sections 4R and 4L, redundant descriptions will be omitted here.

In the wearable speaker 1 having vibration sections 4R and 4L, it is possible that, because of the difference in user's body shape and clothing worn and the difference in tactile sensation between the respective users, the relative positions between the body and the vibration sections 4R and 4L may vary from one user to another at the positions of the vibration sections 4R and 4L fastened on top of a housing 2 of the wearable speaker 1. Accordingly, it is possible that the vibration sections 4R and 4L may not be in contact with adequate parts of the body and that the wearable speaker 1 may not be capable of fully achieving its intended vibration transfer efficiency.

Accordingly, in the second embodiment, the vibration sections 4R and 4L are configured to be movable with respect to the housing 2. Traveling rails 27R and 27L are provided on the lower surfaces of the arms 21R and 21L as illustrated in FIG. 10(B), allowing the vibration sections 4R and 4L to move along the traveling rails 27R and 27L. Accordingly, the vibration sections 4R and 4L can move in directions of arrows illustrated in FIGS. 10(A) and 10(B) on the lower surfaces of the arms 21R and 21L. In other words, the right and left vibration sections 4R and 4L have traveling mechanisms to change their relative positions with respect to the speakers 3R and 3L, respectively. The user wearing the wearable speaker 1 can experience suitable vibrations by moving and positioning the vibration sections 4R and 4L at locations suitable for the user. It should be noted that the right and left vibration sections 4R and 4L can be moved independently of each other and that the user can position the vibration sections 4R and 4L at horizontally asymmetric positions.

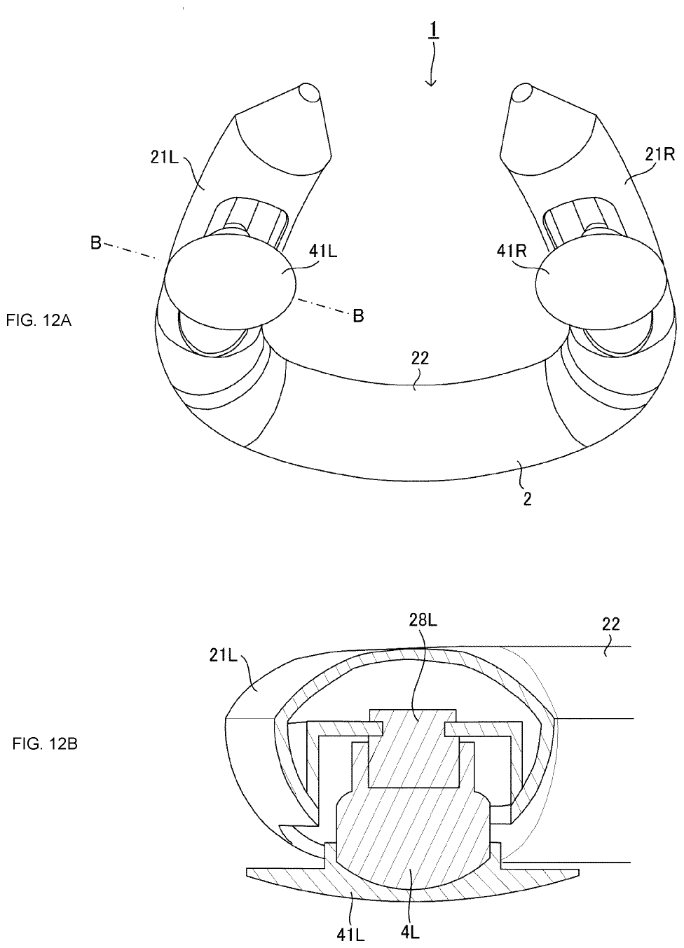

Also, in the second embodiment, the vibration sections 4R and 4L can be moved in the directions of being pressed against the user's body. FIG. 11 is a cross-sectional view of nearby areas of the vibration sections 4R and 4L in FIG. 10(B). In the present embodiment, the vibration sections 4R and 4L can be moved vertically in FIG. 11 with respect to base sections 28R and 28L provided inside the arms 21R and 21L. In FIG. 11, the vibration section 4L located on the left has been moved upward, and the vibration section 4R located on the right has been moved downward. The vertical movements of the vibration sections 4R and 4L can be achieved in various manners, one example of which is to fasten the vibration sections 4R and 4L to the base sections 28R and 28L with screws and vertically move the vibration sections 4R and 4L by rotating the vibration sections 4R and 4L.

As described above, it is possible, by providing traveling mechanisms that allow the vibration sections 4R and 4L to move in a direction of being pressed against the user's body, that is, in a direction of going out of or back into the housing 2, to change the relative positions between the housing 2 and the vibration sections 4R and 4L and thereby change loads of the arms 21R and 21L exerted on the vibration sections 4R and 4L and adjust intensities of the vibrations transferred to the user. In the case where the vibration sections 4R and 4L are positioned downward, large vibrations can be realized, and in the case where the vibration sections 4R and 4L are positioned upward, small vibrations can be realized. Also, independently moving the right and left vibration sections makes it possible to correct the difference in intensity between the right and left vibrations perceived by a wearer caused by individual difference.

Also, in the case where the material and shape of the surfaces of the vibration sections 4R and 4L are fixed, there is a problem that the users cannot experience vibrations in the same manner because the tactile sensation varies from one user to another. Also, there is a problem that, in practice, the tactile sensation also changes depending on a physical condition, a mood, and clothing of the user. Accordingly, in the second embodiment, covers 41R and 41L can be attached to the vibration sections 4R and 4L. Attaching or changing the covers 41R and 41L makes it possible to change a vibration sensation to a different one.

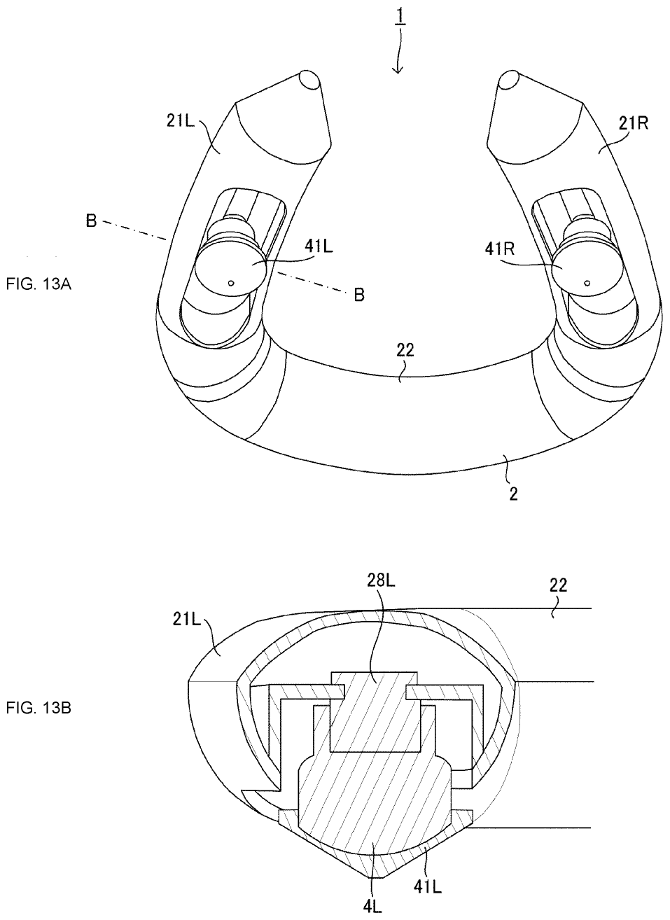

FIG. 12 depicts diagrams illustrating the wearable speaker 1 to which the covers 41R and 41L have been attached. FIG. 12(A) is a perspective view of the wearable speaker 1 as seen from below, and FIG. 12(B) is a cross-sectional view of the arm 21L taken along B-B illustrated in FIG. 12(A). The covers 41R and 41L have an elastic coefficient different from that of hard vibration surfaces of the vibration sections 4R and 4L. For example, if soft covers such as urethane covers are attached as the covers 41R and 41L, the vibrations can be reduced, making it possible to mitigate the vibrations generated by the vibration sections 4R and 4L.

Further, the lower surfaces of the covers 41R and 41L illustrated in FIGS. 12(A) and 12(B) are larger in shape than the vibration surfaces of the vibration sections 4R and 4L. The covers 41R and 41L expand vibration surfaces that come into contact with the user, making it possible to add variations to a normal usage according to user's preferences and to widen the way of enjoying the wearable speaker 1. In particular, if the vibration sections 4R and 4L are accommodated in the arms 21R and 21L as in the present embodiment, vibration surfaces equal to or greater than the arms 21R and 21L in thickness cannot be provided. However, it is possible to create vibration surfaces larger than the thicknesses of the arms 21R and 21L by attaching the covers 41R and 41L.

FIG. 13 depicts diagrams illustrating the wearable speaker 1 to which the covers 41R and 41L different from those illustrated in FIG. 12 have been attached. FIG. 13(A) is a perspective view of the wearable speaker 1 as seen from below, and FIG. 13(B) is a cross-sectional view of the arm 21L taken along B-B illustrated in FIG. 13(A).

The covers 41R and 41L illustrated in FIG. 13 have a conic structure that protrudes downward and include a hard material such as ABS resin or acrylic resin. The covers 41R and 41L in such a shape allow vibrations to be efficiently transferred to the user near summits of the cones, making it possible to transfer vivid vibration stimuli with precision.

Although the covers 41R and 41L that can be attached to the vibration sections 4R and 4L have been described above with reference to FIGS. 12 and 13, using different materials and shapes of the covers 41R and 41L makes it possible to change the covers 41R and 41L according to user's preferences and add variations, according to user's preferences, to the normal usage in which the covers 41R and 41L are not employed and to widen the way of enjoying the wearable speaker 1.

As described above, according to the wearable speaker 1 of the second embodiment, providing traveling mechanisms that allow movement of the vibration sections 4R and 4L makes it possible for the user to move the vibration sections 4R and 4L to positions suitable for the user and experience suitable vibrations. Also, it is possible to experience different vibrations by using the covers 41R and 41L including an appropriate material or having an appropriate shape that can be attached to the vibration sections 4R and 4L.

### 3. Modification Examples

Although the vibration sections 4R and 4L a part of which is embedded in the arms 21R and 21L have been described in the first and second embodiments, the manner of attaching the vibration sections 4R and 4L is not limited to such embodiments and can use a variety of manners.

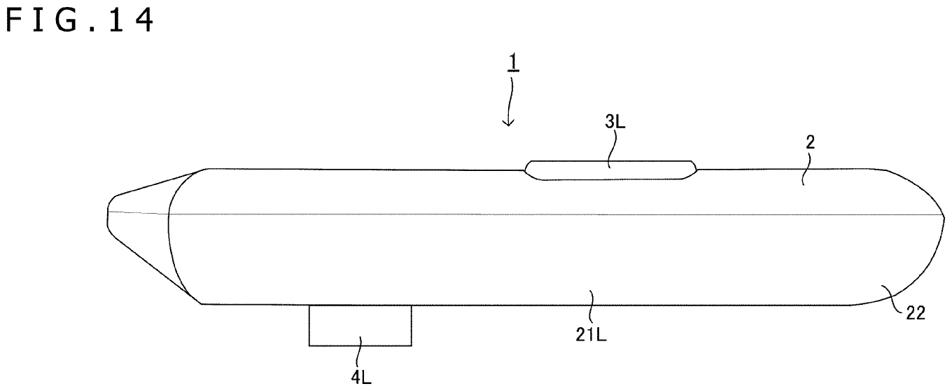

FIG. 14 is a side view of the wearable speaker 1. It should be noted that the housing 2 of the wearable speaker 1 illustrated in FIGS. 14 to 16 has a shape similar to that of the wearable speaker 1 described with reference to FIG. 1 and that top and bottom views are omitted. In the wearable speaker 1 illustrated in FIG. 14, the vibration section 4L is provided outside the housing 2 and on the lower surface of the arm 21L (and the vibration section 4R is similarly provided outside the housing 2 and on the lower surface of the arm 21R). As described above, providing the vibration section 4L outside the housing 2 makes it possible to reliably separate an internal space of the housing 2 on which back pressures of the speakers 3R and 3L are exerted from the vibration sections 4R and 4L and to prevent audio and vibrations from interfering with each other.

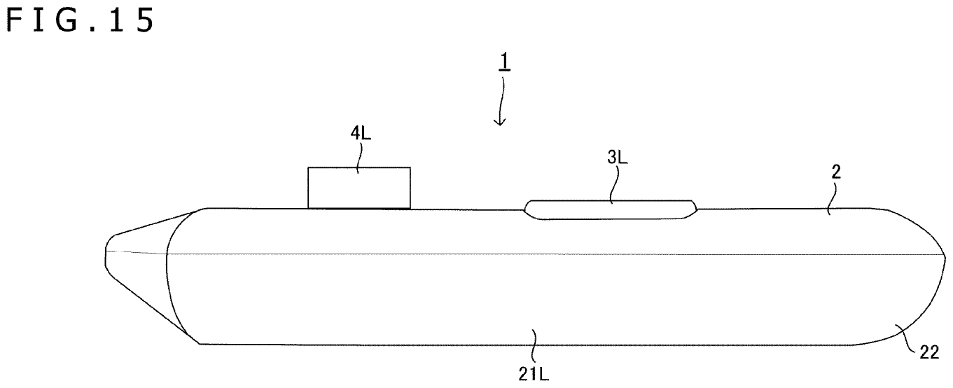

FIG. 15 is a side view of the wearable speaker 1, and in the present embodiment, the vibration section 4L is attached to the upper surface of the arm 21L (and the vibration section 4R is similarly attached to the upper surface of the arm 21R). As described above, the vibration sections 4R and 4L need not necessarily be provided at positions that come into contact with the user. The vibrations generated by the vibration sections 4R and 4L may be indirectly transferred to the user via the housing 2. As described above, in the case where the vibration sections 4R and 4L are attached to the upper surfaces of the arms 21R and 21L, the vibrations generated by the vibration sections 4R and 4L propagate across the housing 2 and are then transferred to the user, making it possible to present vibrations to a wide region.

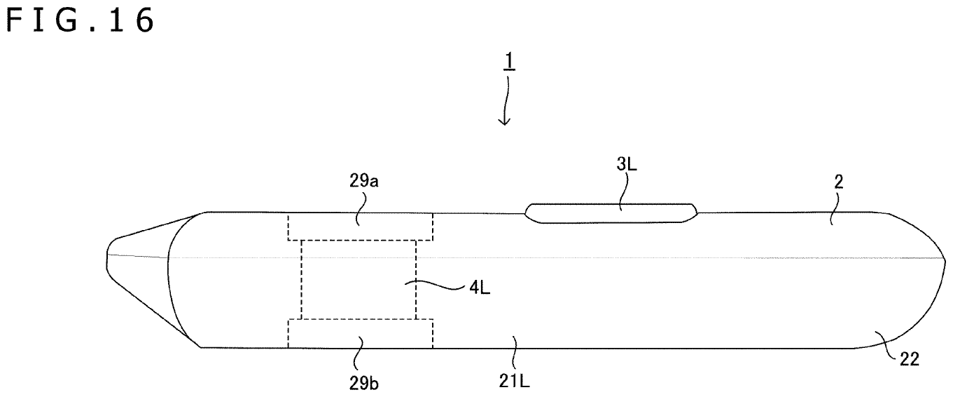

FIG. 16 is a side cross-sectional view of the wearable speaker 1, and in the present embodiment, the vibration section 4L is attached to the inside of the arm 21L (and the vibration section 4R is similarly attached to the inside of the arm 21R). The vibration section 4L is attached to the arm 21L inside the arm 21L via attachment sections 29a and 29b. When the vibration sections 4R and 4L are attached in such a manner, the vibrations of the vibration sections 4R and 4L are transferred to the arms 21R and 21L via the attachment sections 29a and 29b, making it possible for the user wearing the wearable speaker 1 to experience the vibrations.

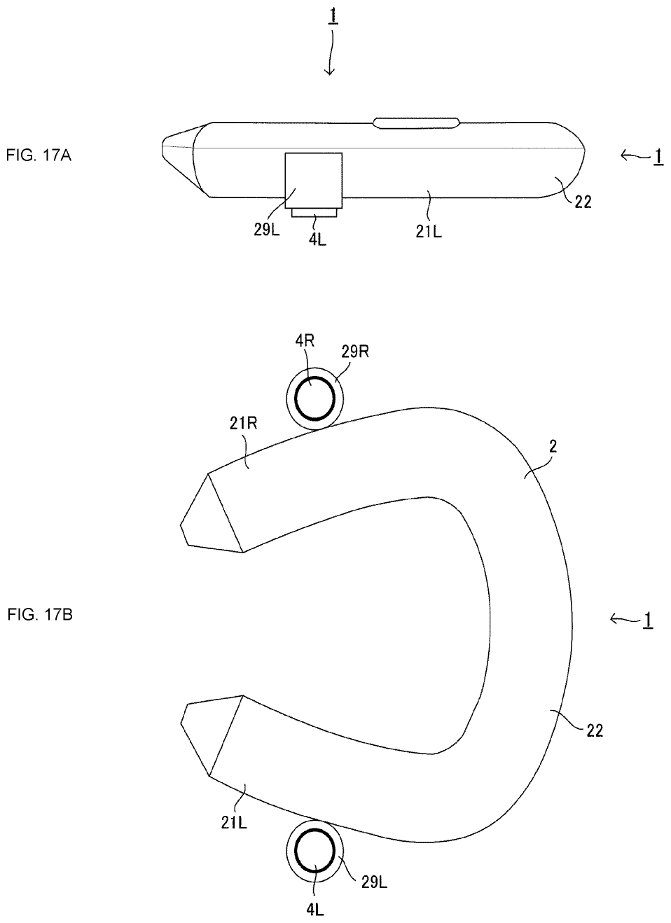

FIG. 17 depicts diagrams describing the manner of attaching the vibration sections 4R and 4L; FIG. 17(A) illustrates a side view of the wearable speaker 1, and FIG. 17(B) illustrates a bottom view of the wearable speaker 1. In the present embodiment, the vibration sections 4R and 4L are attached to outer side surfaces of the right and left arms 21R and 21L via attachment sections 29R and 29L. In the case where the vibration sections 4R and 4L are attached to the outer side surfaces of the arms 21R and 21L, the vibration sections 4R and 4L are arranged independently of the housing 2. Accordingly, the vibration sections 4R and 4L are freed from size restrictions, making it possible to use the vibration sections 4R and 4L that can produce larger and more intense vibrations. Also, because the vibration sections 4R and 4L come into contact with the body of a user, the vibrations generated by the vibration sections 4R and 4L are directly transferred to the user, making it possible to present vivid vibration stimuli.

A description will next be given of modification examples of the vibration section 4 (4R or 4L). FIG. 18 depicts a modification example of the vibration section 4. In the first embodiment described with reference to FIG. 1 and the like, the vibration surface of the vibration section 4 that comes into contact with the user is a flat surface. In this modification example, a vibration surface 4a is a projecting curved surface. Using a curved surface as the vibration surface 4a makes it possible to provide a better fit for the user and to more suitably transfer the vibrations to the user. It should be noted that the vibration sections 4R and 4L having curved vibration surfaces are also used in the second embodiment as in FIG. 18.

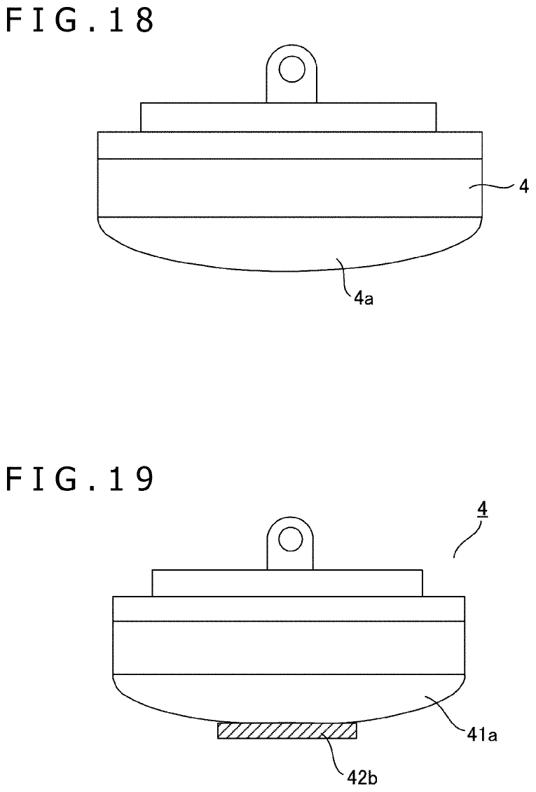

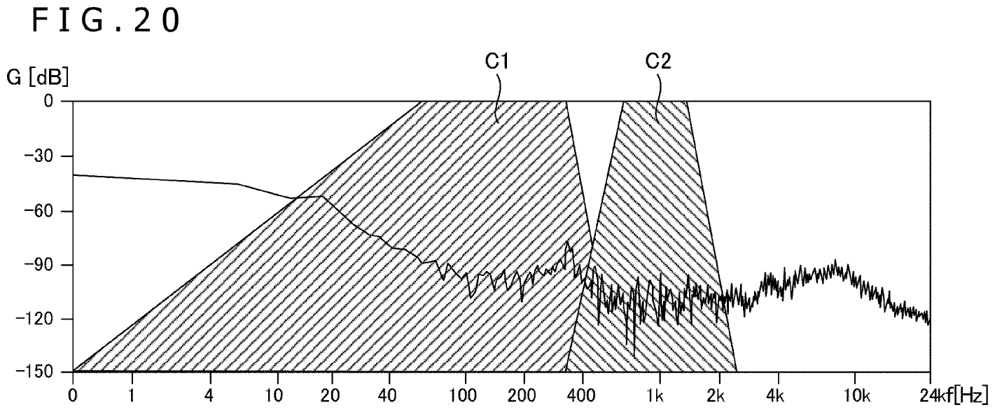

FIG. 19 is a diagram illustrating a modification example of the vibration section 4, and the vibration section 4 includes a combination of a first vibration section 41a and a second vibration section 42b. Here, the first vibration section 41a and the second vibration section 42b have different characteristics. In the present embodiment, a voice coil motor is used as the first vibration section 41a, and a piezo actuator is used as the second vibration section 42b. The second vibration section 42b is pasted (bonded in the present embodiment) to the lower surface of the first vibration section 41a. In the first vibration section 41a using a voice coil motor, there is a possibility that the vibration intensity of a high frequency band required for a shock-like vibration with a sharp rising edge may be insufficient. Accordingly, the second vibration section 42b using a piezo actuator is provided to secure a vibration intensity in the high frequency band.

FIG. 20 illustrates a frequency characteristic (spectrum) for FIG. 8(A) as does FIG. 8(B). Here, a shaded area C1 illustrated in FIG. 20 is a band-pass filter (with an effective passband from approximately 20 to 500 Hz) used in a vibration signal that drives the first vibration section 41a, and a shaded area C2 is a band-pass filter (with an effective passband from approximately 500 Hz to approximately 2 kHz) used in a vibration signal that drives the second vibration section 42. As described above, applying a band-pass filter having an appropriate band with respect to the first vibration section 41a and the second vibration section 42b and creating vibration signals make it possible to allow the user to experience vibrations using effective frequency bands on the first vibration section 41a and the second vibration section 42b. Also, as in the present embodiment, pasting the second vibration section 42b to the vibration surface of the first vibration section 41a makes it possible to cause one to experience the vibrations of the first vibration section 41a and the second vibration section 42b at the same contact position. In particular, bringing a piezo actuator (second vibration section 42b) with a low vibration intensity into direct contact with the human body makes it possible to efficiently transfer high frequency vibrations.

Although various embodiments and modification examples have been described above, the vibration section 4 to be used in the wearable speaker 1 can be provided not only one on each of the left and right arms 21R and 22R but also in larger numbers to suit such a purpose as causing vibrations to propagate to a wide region of the user's upper half of the body.

The present disclosure can be realized by an apparatus, a method, a system, or the like. Also, the matters described in the respective embodiments and modification examples can be combined as appropriate. It should be noted that the contents of the present disclosure are not to be interpreted in a limited manner by the advantageous effects described in the present disclosure.

The present disclosure can also have the following configurations.

(1) A wearable speaker including:

a housing to be used by being hung around a neck of a user or carried on a shoulder of the user;

a speaker capable of reproducing an audio signal; and

one or more vibration sections capable of reproducing vibration signals.

(2) The wearable speaker of feature (1), in which

the vibration section is provided in plural number.

(3) The wearable speaker of feature (2), in which

the vibration sections provided in plural number have different characteristics.

(4) The wearable speaker of feature (2), in which

the vibration sections are positioned in such a manner as to transfer vibrations to left and right sides of a body of the user when the user wears the wearable speaker.

(5) The wearable speaker of any one of features (1) to (4), in which

a part of the vibration section is embedded in the housing.

(6) The wearable speaker of any one of features (1) to (5), in which

a sound absorbing material is arranged around the vibration section.

(7) The wearable speaker of any one of features (1) to (6), in which

the vibration section is attached to the housing via a cushioning material.

(8) The wearable speaker of any one of features (1) to (7), further including:

traveling mechanisms that allow the vibration section to move in such a manner as to change a relative position of the vibration section with respect to the speaker.

(9) The wearable speaker of any one of features (1) to (8), further including:

traveling mechanisms that allow the vibration section to move in a direction of coming into contact with the user.

(10) The wearable speaker of any one of features (1) to (9), in which

the vibration section is attached to the housing via a support section.

(11) The wearable speaker of feature (10), in which

the support section is rotatable.

(12) The wearable speaker of any one of features (1) to (11), further including:

a cover that is attachable to the vibration section.

(13) The wearable speaker of any one of features (1) to (12), in which

the housing is used by being hung around the neck of the user or carried on the shoulder of the user.

### REFERENCE SIGNS LIST

1: Wearable speaker

2: Housing

3R, 3L: Speakers

(4R, 4L): Vibration sections

4a: Vibration surface

21R, 21L: Arms

22: Connection section

23R, 23L: Opening sections

24: Support section

25: Sound absorbing material

26: Cushioning material

27R, 27L: Traveling rails

28R, 28L: Base sections

29R, 29L: Attachment sections

29a, 29b: Attachment sections

31: Frame sync word

32: Frame information

33: Audio data

34: Vibration data

41R, 41L: Covers

41a: First vibration section

42b: Second vibration section

51: Analysis section

52: Audio signal control section

53: Audio signal DAC

54: Audio signal amplifier

55: Vibration signal control section

56: Vibration signal DAC

57: Vibration signal amplifier

241, 242: Hinge sections

243: Base section

1. A wearable speaker comprising:
a housing to be used by being hung around a neck of a user or carried on a shoulder of the user;
a speaker capable of reproducing an audio signal; and
one or more vibration sections capable of reproducing vibration signals.

2. The wearable speaker of claim 1, wherein
the vibration section is provided in plural number.

3. The wearable speaker of claim 2, wherein
the vibration sections provided in plural number have different characteristics.

4. The wearable speaker of claim 2, wherein
the vibration sections are positioned in such a manner as to transfer vibrations to left and right sides of a body of the user when the user wears the wearable speaker.

5. The wearable speaker of claim 1, wherein
a part of the vibration section is embedded in the housing.

6. The wearable speaker of claim 1, wherein
a sound absorbing material is arranged around the vibration section.

7. The wearable speaker of claim 1, wherein
the vibration section is attached to the housing via a cushioning material.

8. The wearable speaker of claim 1, further comprising:
traveling mechanisms that allow the vibration section to move in such a manner as to change a relative position of the vibration section with respect to the speaker.

9. The wearable speaker of claim 1, further comprising:
traveling mechanisms that allow the vibration section to move in a direction of coming into contact with the user.

10. The wearable speaker of claim 1, wherein
the vibration section is attached to the housing via a support section.

11. The wearable speaker of claim 9, wherein
the support section is rotatable.

12. The wearable speaker of claim 1, further comprising:
a cover that is attachable to the vibration section.

13. The wearable speaker of claim 1, wherein
the housing is used by being hung around the neck of the user or carried on the shoulder of the user.
